(19) United States
(12) Patent Application Publication
(10) Pub. No.: US 2026/0054119 A1
(43) Pub. Date: Feb. 26, 2026

(54) SYSTEM AND METHODS FOR PHOTOACTIVATED REDUCTIVE DEFLUORINATION OF PFAS IN A SAMPLE

(71) Applicant: Enspired Solutions Inc., Lansing, MI (US)

(72) Inventors: Denise Kay, Laingsburg, MI (US); Meng Wang, Chicago, IL (US); Suzanne Witt, Lansing, MI (US)

(73) Assignee: Enspired Solutions Inc., Lansing, MI (US)

(21) Appl. No.: 19/305,388

(22) Filed: Aug. 20, 2025

Related U.S. Application Data
(60) Provisional application No. 63/685,525, filed on Aug. 21, 2024.

(51) Int. Cl. A62D 3/176; A62D 3/34; A62D 3/40; A62D 101/22

(52) U.S. Cl. CPC A62D 3/176; A62D 3/34; A62D 3/40; A62D 2101/22

(57) ABSTRACT

Systems and methods are provided for degrading PFAS in a semi-solid sample. The semi-solid sample includes PFAS molecules in a partially liquid solution. An electron donor, and optionally a surfactant, are introduced into the mixture, forming micelles. An electron donor associates with the micelle surface and releases hydrated electrons upon exposure to UV light to initiate the reductive defluorination reaction, resulting in fluoride, water, and simple carbon compounds.

### CROSS REFERENCES TO RELATED APPLICATIONS

This application claims the benefit of and priority to U.S. Provisional Patent Application No. 63/685,525, filed Aug. 21, 2024, which is incorporated herein by reference in its entirety.

### BACKGROUND OF THE INVENTION

### 1. Field of the Invention

Per- and polyfluoroalkyl substances (PFAS) are a class of synthetic chemicals prevalent in various industrial applications and consumer products due to their desirable properties, such as resistance to heat, water, and oil. Despite their utility, PFAS are environmentally persistent and have been linked to adverse health effects, making their treatment and removal from environmental matrices an area of significant concern. Addressing PFAS contamination, particularly in semi-solid slurries, remains a critical challenge in environmental engineering.

The described technology relates to a reactor system and associated methods thereof configured for the decomposition of PFAS in semi-solid slurries, utilizing electron donors and optionally micelles and ultraviolet (UV) light to achieve reductive defluorination. Key terms associated with this technology include PFAS degradation, electron donors, micelles, UV light, defluorination, and semi-solid slurries.

### 2. Description of the Prior Art

Existing technologies for PFAS decomposition include thermal methods, such as incineration, pyrolysis, and supercritical water oxidation (SCWO). These methods require high energy inputs, operate under extreme conditions, and may generate harmful byproducts. Furthermore, such approaches often necessitate complex and expensive infrastructure, which limits their widespread adoption. Chemical oxidation techniques have also been employed to decompose PFAS; however, these methods often involve harsh reagents and can result in incomplete degradation, leading to the formation of side products that may still pose environmental risks.

Mechanical filtration and adsorption techniques, such as granular activated carbon (GAC) and ion exchange resins, represent another category of PFAS treatment methods. These techniques primarily transfer PFAS from one phase to another rather than achieving complete degradation. Consequently, the disposal of spent adsorbents or secondary waste streams still poses a significant environmental challenge. Additionally, these methods may be less effective for semi-solid slurries where PFAS are distributed between solid and liquid phases, requiring a more integrated approach to capture and treat the contaminants efficiently.

What is needed is a treatment system that can effectively decompose PFAS in semi-solid slurries that reduces energy consumption and eliminates the formation of toxic byproducts.

Prior art patent documents include the following:

U.S. Pat. No. 9,896,350 for a method of degrading perfluorinated compound by inventors Cheng Gu et al., filed Dec. 18, 2016, and issued Feb. 20, 2018, is directed to the technical field of degradation of persistent pollutants and discloses a method for efficiently degrading a perfluorinated compound (PFC), through which the problems of harsh reaction conditions and less high defluorination rate existing in prior-art methods for degrading PFCs are solved. U.S. Pat. No. 9,896,350 discloses a 3-indoleacetic acid (IAA) solution irradiated with 254 nm UV light to generate hydrated electrons, with which the PFC are degraded by reduction under an aerobic condition, where an organo-modified montmorillonite is added to provide a reaction microzone, so the degradation and defluorination effects of the hydrated electrons for the PFC are greatly improved. The method for degrading a PFC according to U.S. Pat. No. 9,896,350 is not affected by the pH of and the dissolved oxygen in the solution and less affected by the humic substances in a water body.

U.S. Pat. No. 11,072,574 for a method for degrading perfluorinated compounds by inventors Cheng Gu et al., filed Jul. 9, 2020, and issued Jul. 27, 2021, is directed to a method for degrading perfluorinated compounds (PFCs) and belongs to the field of degradation of persistent pollutants. U.S. Pat. No. 11,072,574 discloses, cetyltrimethylammonium bromide (CTAB), indoleacetic acid (IAA) and PFCs mixed together to form compact self-assembled micelles, and the self-assembled micelles are illuminated, so that PFCs are rapidly degraded and defluorinated in the micelles, thereby realizing the degradation of PFCs by using a self-assembled micelle system.

U.S. Patent Pub. No. 2022/0401777 for a nano-reactor system for decomposition of per- and polyfluoroalkyl substances by inventors Hui Li et al., filed Nov. 7, 2020, and published Dec. 22, 2022, is directed to a reactor system for decomposing at least one of a per- or polyfluoroalkyl substance (PFAS). The system includes a material having an interior surface that defines a compartment; a subaqueous liquid in the compartment; and an electron donor in the subaqueous liquid, the electron donor configured to release a hydrated electron upon ultraviolet (UV) irradiation. The reactor system is configured so that when the electron donor releases a hydrated electron into the subaqueous liquid, the hydrated electron has a longer lifespan relative to an electron released in normal bulk phase water, and when a PFAS is present within the subaqueous liquid, the hydrated electron is capable of reductively defluorinating the PFAS and to generate fluoride ions.

### SUMMARY OF THE INVENTION

Effective techniques for destruction of PFAS in solids are scarce, as most efforts have focused on aqueous PFAS treatments that do not translate to solids. Technologies currently in use or development for PFAS destruction in semi-solid slurries include incineration, hydrothermal liquefaction (HTL), supercritical water oxidation (SCWO), pyrolysis, and aerobic and anaerobic digestion.

An energy efficient and environmentally friendly system for defluorinating PFAS is disclosed herein, which can be integrated into existing machinery and manufacturing lines. The systems and methods of the present disclosure include a mixture formed from a semi-solid slurry and electron donor, and a UV light source adapted to expose the mixture to UV light to defluorinate or degrade the PFAS contained in the mixture.

In one embodiment, the present invention is related to a system for defluorinating per- and polyfluorinated substances (PFAS) in semi-solid slurries, including a semi-solid slurry including liquid, solid, and PFAS, an electron donor, and an ultraviolet (UV) light source, wherein the electron donor is combined with the semi-solid slurry to form a mixture, and wherein the electron donor is capable of releasing hydrated electrons upon UV light irradiation from the UV light source.

In another embodiment, the present invention is related to a method for defluorinating per- and polyfluorinated substances (PFAS) in a semi-solid slurry, including introducing an electron donor into the semi-solid slurry to form a mixture, the electron donor releasing hydrated electrons upon ultraviolet (UV) light irradiation, and irradiating the mixture with UV light with at least one UV light source designed to maximize light penetration within the mixture and enhance UV exposure of the mixture, wherein irradiating the mixture defluorinates the PFAS.

In yet another embodiment, the present invention is related to a system for defluorinating per- and polyfluorinated substances (PFAS) in semi-solid slurries, including a semi-solid slurry including liquid, solid, and PFAS, an electron donor, a surfactant including amphiphilic lipids with at least one hydrocarbon tail and at least one cationic polar head group capable of forming micelles in the mixture and facilitating desorption of PFAS from the semi-solid slurry and concentrating the PFAS within the micelles, and an ultraviolet (UV) light source, wherein the electron donor and the surfactant are combined with the semi-solid slurry to form a mixture, and wherein the electron donor is capable of releasing hydrated electrons upon UV light irradiation from the UV light source.

One advantage to the disclosed systems and methods is that PFAS does not have to be isolated from the solid sample first, which drastically reduces the overall waste volume and treatment cost to degrade PFAS.

### BRIEF DESCRIPTION OF THE DRAWINGS

FIG. 1A illustrates the molecular structure of a representative PFAS molecule in a semi-solid slurry environment.

FIG. 1B illustrates PFAS molecules integrated in a micelle by adding surfactant according to one embodiment of the present invention.

FIG. 1C illustrates an electron donor associated with the micelle surface according to one embodiment of the present invention.

FIG. 1D illustrates the release of hydrated electrons upon exposure to UV light to initiate the reductive defluorination reaction, resulting in the degradation of PFAS to fluoride, water, and simple carbon compounds according to one embodiment of the present invention.

FIG. 2 illustrates a system for degradation of PFAS including a reaction vessel according to one embodiment of the present invention.

### DETAILED DESCRIPTION

A system of the present disclosure includes an environment for degrading PFAS in a semi-solid sample via a photoactivated reductive defluorination (PRD) reaction. Additionally, methods of degrading PFAS using the system of the present disclosure are also described.

In one embodiment, the present invention is related to a system for defluorinating per- and polyfluorinated substances (PFAS) in semi-solid slurries, including a semi-solid slurry including liquid, solid, and PFAS, an electron donor, and an ultraviolet (UV) light source, wherein the electron donor is combined with the semi-solid slurry to form a mixture, and wherein the electron donor is capable of releasing hydrated electrons upon UV light irradiation from the UV light source.

In another embodiment, the present invention is related to a method for defluorinating per- and polyfluorinated substances (PFAS) in a semi-solid slurry, including introducing an electron donor into the semi-solid slurry to form a mixture, the electron donor releasing hydrated electrons upon ultraviolet (UV) light irradiation, and irradiating the mixture with UV light with at least one UV light source designed to maximize light penetration within the mixture and enhance UV exposure of the mixture, wherein irradiating the mixture defluorinates the PFAS.

In yet another embodiment, the present invention is related to a system for defluorinating per- and polyfluorinated substances (PFAS) in semi-solid slurries, including a semi-solid slurry including liquid, solid, and PFAS, an electron donor, a surfactant, and an ultraviolet (UV) light source, wherein the electron donor and the surfactant are combined with the semi-solid slurry to form a mixture, and wherein the electron donor is capable of releasing hydrated electrons upon UV light irradiation from the UV light source.

In one embodiment, the present invention is directed to micelle-accelerated photoactivated reductive defluorination (PRD) of PFAS, wherein the molecules of PFAS in water are trapped in micelles created by added surfactant, an electron donor associates with the micelle surface, and releases hydrated electrons upon exposure to a UV light to initiate the reductive defluorination reaction, resulting in the degradation of PFAS to fluoride, water, and simple carbon compounds.

In another embodiment, the present invention is directed to PRD of PFAS without an added surfactant to facilitate micelle formation such that an electron donor is either in the liquid or associates with micelles formed by native surfactants in the liquid, wherein the electron donor releases hydrated electrons upon exposure to UV light to initiate the reductive defluorination reaction, resulting in the degradation of PFAS to fluoride, water, and simple carbon compounds. The following terms have the following meanings:

An “electron donor” means a compound capable of releasing hydrated electrons upon UV irradiation.

A “surfactant” means a compound that forms micelles, wherein the micelle is formed from amphiphilic lipids including 1 hydrocarbon tail, 2 hydrocarbon tails, 3 hydrocarbon tails, or a combination thereof, and a polar head group, preferably a cationic polar head group.

A “light path length” means the distance that the incident light travels through a sample.

A “semi-solid slurry” means a mixture of solid and liquid, including PFAS.

“Degradation” as it relates to the PRD reaction to degrade PFAS means about a 60% to about a 99% defluorination of the total PFAS in a sample.

In one aspect, a system is disclosed including a mixture of a semi-solid slurry and electron donor, wherein the mixture is exposed to UV irradiance. In some embodiments, the mixture further includes a surfactant.

The semi-solid slurry may include liquid and solid material. The liquid may include water. In some embodiments, the liquid consists essentially of water. In some embodiments, the liquid is water. The solid material may be formed of any environmental solid such as soil, dirt, sludge, sewage, landfill debris, garbage, sand, waste from a manufacturing process, spent sorbents, GAC, ion exchange resin, cyclodextrin, etc. The solid may contain particles having an average diameter ranging from about 0.001 nm to about 500 mm. The solid may be processed before being mixed with the liquid to form the semi-solid slurry. For example, the solid may be ground into a desired average particle size, which may be collected via a sieve. The solid or slurry may also be mixed with an acid or base to lower or raise the pH of the solid prior to mixing with the liquid, or the solid or slurry may be mixed with a composition to neutralize, deactivate, or activate some element within the solid so that it is optimized for the system and the PRD reaction.

The semi-solid slurry may include about 99.9 wt. % liquid and about 0.1 wt. % solid. In some embodiments, the semi-solid slurry may include about 20 wt. % liquid and about 80 wt. % solid. In some embodiments, the semi-solid slurry may include a liquid in the range of about 20 wt. % to about 99.9 wt. % and a solid in the range of about 80 wt. % to about 0.1 wt. % and all values in between those two ratios.

The mixture may include a semi-solid slurry and an electron donor, wherein the electron donor is a compound capable of releasing a hydrated electron upon UV irradiation. Example electron donors include, but are not limited to, a carboxylate that associates with the positively charged surface, a carboxylate that electrostatically associates with the surface, an indole acetic acid (IAA), ascorbic acid (AA), kojic acid (deprotonated to form anions), various organic or biomolecules having conjugated structures, and combinations thereof.

The mixture may include an amount of about 0.01 wt. % to about 75 wt. % of an electron donor. The mixture may include an amount of about 0.01 wt. % to about 99.9 wt. % semi-solid slurry. For example, the mixture may include an amount of about 5 wt. % electron donor to about 95% semi-solid slurry. In some embodiments, the mixture further includes a surfactant.

The surfactant may be cationic. In some embodiments, the surfactant may include cetyltrimethyl ammonium chloride (CTAC). In some embodiments, the surfactant may include cetyltrimethyl ammonium bromide (CTAB). In some embodiments, the surfactant may include hexadecyl trimethyl ammonium bromide. Other examples of surfactants that may be included the mixture include but are not limited to primary, secondary, and tertiary amines (pH<10), e.g., octenidine dihydrochloride (which is a gemini surfactant), quaternary ammonium, such as dodecyltrimethylammonium bromide (DTAB), tetradecyltrimethylammonium bromide (TTAB), cyltrimethylammoniump-toluene sulfonate (CTAT), octadecyltrimethylammonium bromide (OTAB), tetradecyltriphenyl phosphonium bromide (TTPB)), cetylpyridinium chloride (CPC), benzalkonium chloride (BAC), tetrabutylammonium chloride (TBAC), benzethonium chloride (BZT), dimethyldioctadecylammonium chloride, dioctadecyldimethylammonium bromide (DODAB), hydroxyethyl laurdimonium chloride, and dimethyldioctadecylammonium chyloride (DODAC), carbonates, such as hydroxymethyl dioxolanon and propylene carbonate, 5-bromo-5-nitro-1,3-dioxane, lecithin, and combinations thereof.

The mixture may include an amount of surfactant ranging from about 0.01 wt. % to about 75 wt. % of the total mixture. As an example, the mixture may include about 70 wt. % semi-solid slurry, about 15 wt. % electron donor, and about 15 wt. % surfactant. The amounts of each component within the mixture may be adjusted as needed to achieve the desired amount of PFAS degradation.

The system of the present disclosure includes exposing the mixture to a UV light source. The UV light source may be selected from any source that produces light within the UV range between about 100 to about 400 nm. The UV light source may be a low-pressure or a medium-pressure UV lamp, or a light emitting diode (LED). The UV light source may include at least one UV light source, such as a lamp. The number of UV light sources will be dependent on the design of the system and the desired percentage of PFAS degradation in the mixture.

Additional information relating to the PRD reaction can be found in U.S. Pat. No. 9,896,350 to Nanjing University and issued Feb. 20, 2018, U.S. Pat. No. 11,072,574 to Nanjing University and issued on Jul. 27, 2021, and U.S. Application Publication No. 2022/0401777 to the Board of Trustees of Michigan State University and published Dec. 22, 2022, the contents of each of these references are incorporated by reference herein in their entirety.

A method of defluorinating PFAS contained in a semi-solid slurry is disclosed, including introducing an electron donor and optionally a surfactant into the slurry to form a mixture. In some embodiments, the electron donor is capable of releasing hydrated electrons upon UV light irradiation. In some embodiments, the method further includes forming micelles in the mixture including amphiphilic lipids with one or more hydrocarbon tails and a cationic polar head group capable of facilitating the desorption of PFAS from solid surfaces and concentrating them within the subaqueous environment of the micelle. In some embodiments, the method includes irradiating the mixture with UV light with one or more UV light sources designed to minimize a light path length and enhance UV exposure of the mixture, wherein the step of irradiating results in defluorinated PFAS.

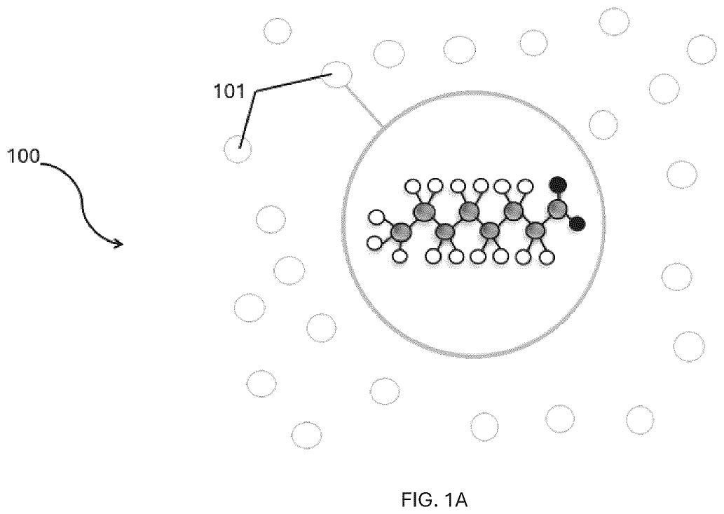

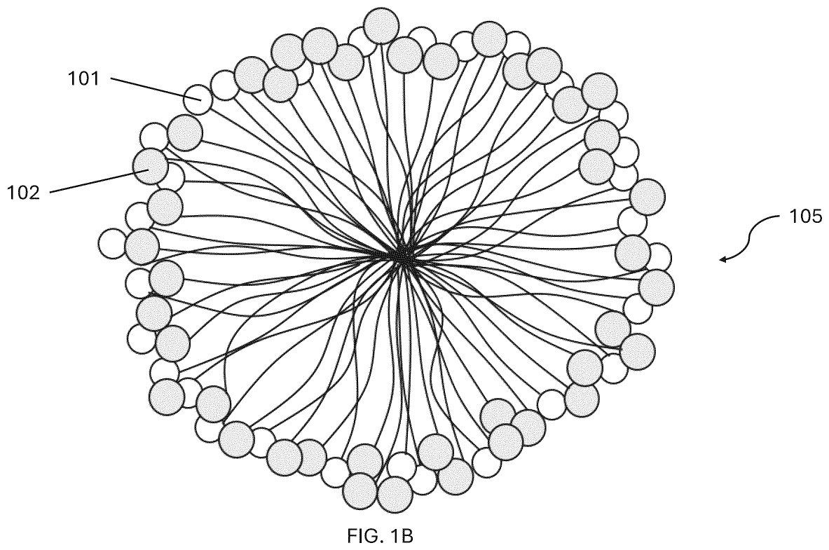

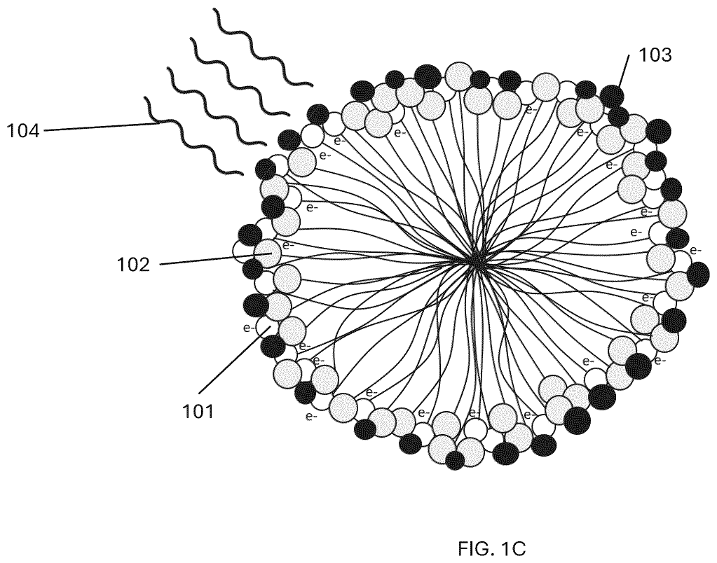

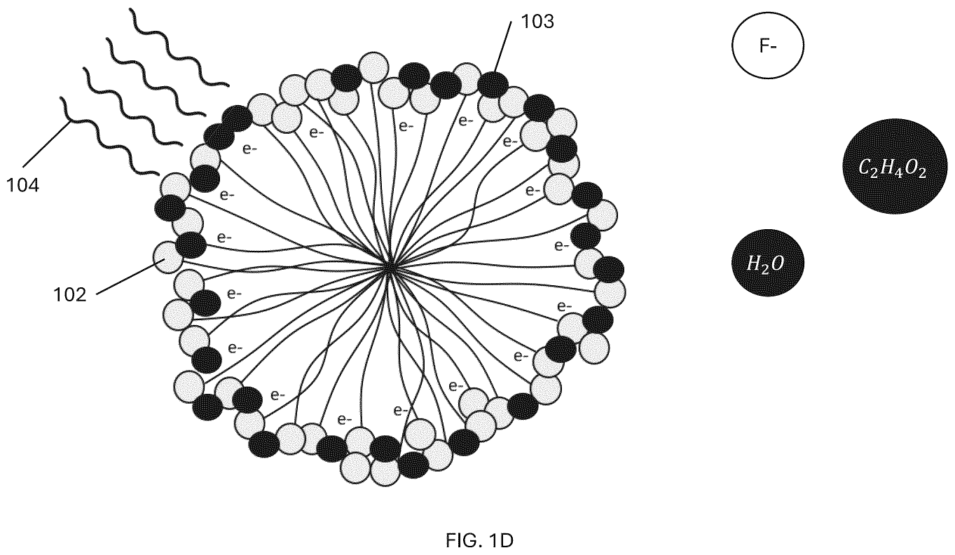

Referring now to the drawings in general, FIG. 1A illustrates the molecular structure of a representative PFAS molecule 101 in a semi-solid slurry environment 100. FIG. 1B illustrates PFAS molecules 101 integrated in a micelle 105 created by adding surfactant 102 to the semi-solid slurry environment according to one embodiment of the present invention. Generally, the surfactant 102 and the PFAS molecules 101 include at least one hydrophobic tail and at least one polar head group. Upon adding the surfactant 102 to the semi-solid slurry environment, the surfactant 102 creates the micelle 105, wherein the hydrophobic portion of the PFAS molecules 101 integrates with the hydrophobic interior portion of the micelle 105, and wherein the polar head group of the PFAS molecules 101 integrates with the polar head groups of the surfactant 102.

After the surfactant 102 is introduced into the semi-solid slurry environment, referring now to FIG. 1C, UV light 104 is applied to the mixture to irradiate an electron donor 103 such that the electron donor 103 is capable of releasing hydrated electrons (depicted as “e-” in FIG. 1C) in the micelle subaqueous environment. FIG. 1C further illustrates an electron donor 103 associated with the micelle surface according to one embodiment of the present invention. Advantageously, because the hydrated electrons are released within the subaqueous environment of the micelle, the hydrated electrons survive long enough to react with a polar head of the PFAS molecule 101 via a reductive reaction.

FIG. 1D illustrates the release of hydrated electrons upon exposure to UV light 104 to initiate the reductive defluorination reaction resulting in the degradation of PFAS molecules to fluoride, water, and simple carbon compounds according to one embodiment of the present invention. In one embodiment, a representative molecule of the simple carbon compound includes acetic acid and/or formic acid. The electron donor 103 releases hydrated electrons, and the hydrated electrons react with the PFAS molecule, sequentially shortening the molecule by one carbon and two fluorine atoms. If the reaction proceeds to complete mineralization of the PFAS molecule, it degrades into three components. Fluoride ions, water molecules, and at least one secondary simple carbon molecule, such as C₂H₄O₂ and/or CH₂O₂. Importantly, throughout the duration of the reaction, the surfactant 102 maintains the structure of the micelle, and the fluoride that is released in the reductive defluorination reaction migrates to the bulk aqueous solution.

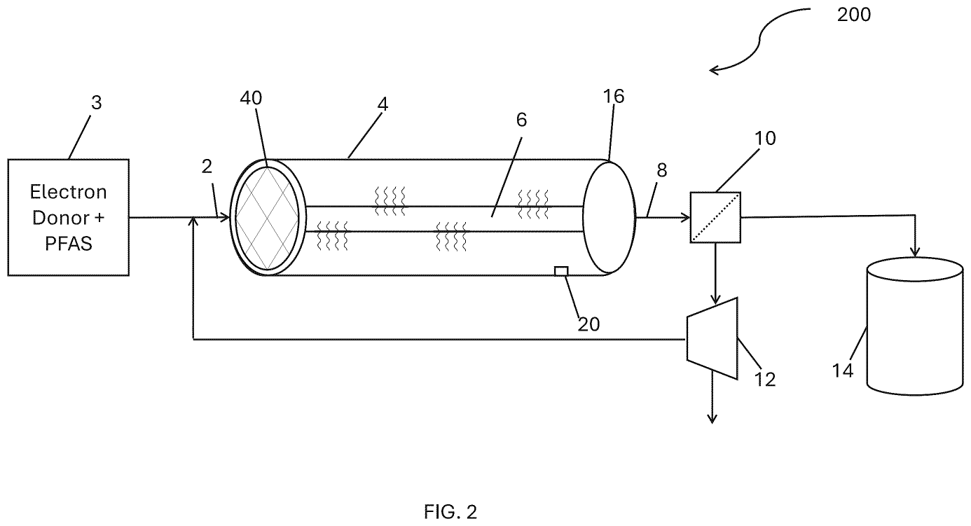

FIG. 2 illustrates a system 200 for degradation of PFAS including a reaction vessel 4 according to one embodiment of the present invention. In one embodiment, the reaction vessel 4 is an open container. In another embodiment, the reaction vessel 4 is a closed container. In another embodiment, the reaction vessel 4 is a flatbed. In another aspect, the system 200 of the present disclosure includes an inlet 2 for introducing a mixture 3 including a semi-solid slurry containing PFAS and an electron donor. In some embodiments, the mixture further includes a surfactant. The reaction vessel 4 includes one or more UV light sources 6. An outlet 8 is coupled to the reaction vessel 4 to remove the defluorinated mixture. In some embodiments, the system 200 may further include a filter 10 for separating solids and one or more pumps 12 for recycling water. The system 200 may further include one or more containers 14 for collecting by-product.

In some embodiments, the inlet 2 includes a reagent introduction point 40. The reagent introduction point 40 includes the electron donor, surfactant, and/or any other reagent configured to interact with the semi-solid slurry as the electron donor, surfactant, and/or any other reagent is introduced into the system 200 and forms a mixture with the semi-solid slurry. In one embodiment, the reagent introduction point 40 includes spraying and/or injecting the electron donor, the surfactant, and/or any other reagent to introduce the electron donor, the surfactant, and/or any other reagent into the semi-solid slurry. The electron donor, the surfactant, and/or any other reagent may be introduced to the semi-solid slurry prior to UV exposure.

In some aspects, the reaction vessel 4 is a coiled tube having an average diameter of about 100 mm to about 750 mm. In one embodiment, the reaction vessel 4 is a flatbed having a height of between about 10 mm to about 10 m, a width of about 10 mm to about 10 m, and a length between about 10 mm to about 10 m. In one embodiment, the reaction vessel 4 is a flatbed having a height of between about 50 mm to about 7 m. In one embodiment, the reaction vessel 4 is a flatbed having a height of between about 1 m to about 3 m. In one embodiment, the reaction vessel 4 is a flatbed having a height of between about 10 mm to about 30 mm. In one embodiment, the reaction vessel 4 is a flatbed having a height of between about 10 mm to about 1 m.

In some embodiments, the reaction vessel 4 is configured to form a light path length from the UV light source 6 to the mixture including the electron donor and PFAS that maximizes the exposure of the electron donor to the UV light. In this manner, the light path length may be from about 1 nm to about 100 mm. In some embodiments, the reaction vessel 4 includes one or more UV light sources 6 that form a light path length from the UV light source 6 to the mixture from about 1 nm to about 10 mm.

In some embodiments, the reaction vessel 4 includes one UV light source 6. In some embodiments, the reaction vessel 4 includes between one and 1000 UV light sources 6. In one embodiment, the reaction vessel 4 includes between one and 10,000 UV light sources 6. In one embodiment, the reaction vessel 4 includes any number of UV light sources 6. The one or more UV light sources 6 may be distributed uniformly, in a pattern, or randomly within the reaction vessel 4. For example, the reaction vessel 4 may include one or more mechanisms for creating turbulent flow, such as a stirrer, a pump, or an impeller. The one or more UV light sources 6 may be distributed along the reaction vessel 4 to expose the mixture to the maximum amount of irradiance. Additionally, the one or more stirrer, pump, and/or impeller may be used to control the mixture flow rate through the reaction vessel 4. The flow rate may be between about 0.01 cm/sec to about 1 m/s. A person having ordinary skill in the art will understand that the flow rate may be adjusted depending on the desired amount of UV irradiance and resulting PFAS degradation.

In one embodiment, the reaction vessel 4 is able to jostle and/or vibrate to allow the electron donor and/or the surfactant to interact with the PFAS contained in the semi-solid slurry. In this embodiment, movement of the reaction vessel 4 creates even distribution of the electron donor and/or surfactant so as to maximize reaction efficiency.

In one embodiment, the reaction vessel 4 is an open container able to receive the semi-solid slurry. In this embodiment, the electron donor, the surfactant, and/or any other reagent is introduced to the semi-solid slurry via spraying the semi-solid slurry.

In another embodiment, the reaction vessel 4 is a closed container. In this embodiment, the electron donor, the surfactant, and/or any other reagent is introduced to the semi-solid slurry via injection of the electron donor, the surfactant, and/or any other reagent into the reaction vessel 4.

The reaction vessel 4 may be coupled to an outlet 8. The outlet 8 may include a gate 16, which prevents the mixture from leaving the reaction vessel 4. In this way, the mixture may have a residence time within the reaction vessel 4. The residence time may be from about 1 second(s) to about 24 hours (h). The gate 16 may be controlled manually or may be controlled electronically by a timer. In some embodiments, the gate 16 may not open until a sensor 20 detects a certain concentration of free fluoride in the reaction vessel.

Once the gate 16 is opened, the mixture may leave the reaction vessel 4 through the outlet 8. The outlet 8 may further include a filter 10 to separate liquid from solids. The solids may be collected in a container 14 for further processing or disposal. In some embodiments, the filtered liquid may be recycled to be used again to form new semi-solid slurry mixtures or may be disposed of properly.

The system 200 may further include mechanisms for keeping the system 200 between about 25 degrees Celsius to about 65 degrees Celsius. The mechanisms for keeping the system at a desired temperature include but are not limited to cooling fans, heat sinks, cooling jackets, or a combination thereof.

The system 200 may further include sensors to detect the pH of the mixture within the system 200. In some embodiments, the pH of the mixture within the system 200 may be anywhere from about 2 to about 14. In some embodiments, the pH of the mixture is maintained between 2 and 6, between 3 and 7, between 3 and 8, or between 4 and 9. In some embodiments, the pH of the mixture is maintained at a pH of about 9 to about 12, or about 10 to about 11. Buffers, bases, and/or acids may be added to maintain the desired pH. The addition of a buffer, base, and/or acid will depend on the components of the mixture materials themselves, including the semi-solid slurry components.

The system 200 may further include sensors that detect the flow rate of the mixture, the amount of fluctuation of free fluoride, the temperature of the reaction vessel 4, and/or the power of each UV light source 6.

In one embodiment, the system 200 includes one or more sensors for detecting pH, free fluoride, flow rate, temperature, etc., pumps for introducing a mixture or controlling the flow rate, and the gate to control the residence time are all in electrical communication with a computer.

In some embodiments, the micelles remain stable at temperatures above approximately 25° C. In some embodiments, the UV light source includes either low-pressure or medium-pressure UV lamps or light emitting diodes (LEDs). The mixture may have a temperature that is maintained between about 40° C. to about 65° C. In some embodiments, the mixture has a pH in the range of about 10 to about 11.

In some embodiments, the mixture has a flow rate within the system ranging from about 0.01 cm/sec to about 1 m/s. The mixture may have a residence time from about 1 second to about 24 hours.

In one embodiment, semi-solid slurries including landfill leachate containing PFAS were treated. These samples were mixed with an electron donor and surfactant and exposed to UV light. Table 1 provides the results of the study below.

TABLE 1
Results of PRD destruction of PFAS in three foam fractionation
concentrated landfill leachate samples with low UVT.

| | L1 (2.0%) | | | L2 (3.4%) | | | L3 (0.4%) | | |
|---|---|---|---|---|---|---|---|---|---|
| Sample | Start | Stop | % | Start | Stop | % | Start | Stop | % |
| (% UVT) | (ng/L) | (ng/L) | destruction | (ng/L) | (ng/L) | destruction | (ng/L) | (ng/L) | destruction |
| PFNA | 4,500 | 100 U | >97% | 20,000 U | 670 U | n/a | 1,700 | 100 U | >94% |
| PFOA | 7,100 | 100 U | >98% | 89,000 | 670 U | >99% | 41,000 | 100 U | >99% |
| PFOS | 6,300 | 100 U | >98% | 20,000 U | 670 U | n/a | 100 U | 100 U | n/a |
| PFHxS | 3,400 | 100 U | >97% | 20,000 U | 670 U | n/a | 11,000 | 100 U | >99% |
| PFBS | 25,000 | 17,000 | 32% | 63,000 | 2,600 | 96% | 1,000 | 100 U | >90% |
| HFPO-DA | 500 U | 500 U | n/a | 40,000 U | 1,300 U | n/a | 200 U | 200 U | n/a |

U = reporting limit
n/a = not applicable
ND = not detected

The PRD reaction in the method of the present disclosure may be performed at ambient temperature and pressure, which contrasts with the other PFAS degradation technologies. Incineration, HTL, SCWO, and pyrolysis systems require temperatures of >1000° C., >250° C., >374° C., and >500° C., respectively, to degrade PFAS. Furthermore, elevated pressures are needed for HTL (>10 MPa) and SCWO (>22 MPa). This is an equipment safety concern, but also can lead to volatilization of PFAS or other substances and necessitates air permitting.

### Additional Embodiments

A system for decomposing at least one type of PFAS in semi-solid slurries. The system includes an electron donor, configured to release hydrated electrons upon UV light irradiation, in the presence of the semi-solid slurry. Hydrated electrons are capable of reductively defluorinating PFAS in the semi-solid slurry, either sorbed to a surface or free in solution.

A system for decomposing at least one type of PFAS in semi-solid slurries. The system includes a micelle with hydrophobic tails on its interior surface and an electron donor configured to release hydrated electrons upon UV irradiation in the presence of the semi-solid slurry. The micelle facilitates desorption of PFAS from solid surfaces, concentration of PFAS in the subaqueous environment of the micelle, and reduces the undesired reaction of the hydrated electron with oxygen. Hydrated electrons are capable of reductively defluorinating PFAS in the semi-solid slurry, whether sorbed to a surface, free in solution, or associated with the micelle.

A semi-solid slurry treatment vessel with a flatbed or coiled tube-style UV reactor, which minimizes the light path length and maximizes the solid surfaces that are exposed to the light.

A semi-solid slurry treatment vessel with turbulent flow that mixes the slurry during UV light exposure.

In some embodiments, the system 200 includes an open container for receiving the slurry. The electron donor may be added to the slurry by spraying. The open container may be jostled or vibrated to allow the electron donor to interact with the PFAS contained in the slurry. In some embodiments, the open container includes a stirrer, such as a stir bar, to mix the electron donor with the slurry. In some embodiments, no mixing of the slurry with the electron donor is required. Once the electron donor is added, the mixture including the slurry and the electron donor is exposed to UV light from one or more UV light sources, resulting in a PRD reaction.

What is claimed is:

1. A system for defluorinating per- and polyfluorinated substances (PFAS) in semi-solid slurries, comprising:
a semi-solid slurry including liquid, solid, and PFAS;
an electron donor; and
an ultraviolet (UV) light source;
wherein the electron donor is combined with the semi-solid slurry to form a mixture; and
wherein the electron donor is capable of releasing hydrated electrons upon UV light irradiation from the UV light source.

2. The system of claim 1, wherein the semi-solid slurry includes an amount of about 50 wt. % liquid and about 50 wt. % solid.

3. The system of claim 1, wherein the UV light source is a low-pressure or a medium-pressure UV lamp.

4. The system of claim 1, wherein the mixture is maintained at a temperature of between about 40° C. to about 65° C.

5. The system of claim 1, wherein the pH of the mixture is maintained in the range of about 10 to about 11.

6. The system of claim 1, further comprising a continuous flow reactor, wherein the mixture has a flow rate of about 0.01 cm/sec to 1 m/s through the continuous flow reactor.

7. The system of claim 1, wherein the mixture has a residence time of about 1 second to about 24 hours.

8. The system of claim 1, further comprising a control system including a temperature control sensor and a pH regulation mechanism.

9. The system of claim 8, wherein the control system includes automated dosing pumps and pH monitoring probes.

10. The system of claim 1, further comprising safety features including cooling fans, spill detectors, leak sensors, gas and liquid pressure sensors, and/or secure storage for chemical reagents.

11. The system of claim 1, further comprising a reaction vessel comprising materials selected from the group consisting of stainless steel, PVC, polypropylene, and high-density polyethylene.

12. The system of claim 1, wherein the system is adaptable to handle semi-solid slurries ranging from 99.9% liquid to 0.1% solid up to 20% liquid to 80% solid.

13. A method for defluorinating per- and polyfluorinated substances (PFAS) in a semi-solid slurry, comprising:
introducing an electron donor into the semi-solid slurry to form a mixture, the electron donor releasing hydrated electrons upon ultraviolet (UV) light irradiation; and
irradiating the mixture with UV light with at least one UV light source designed to maximize light penetration within the mixture and enhance UV exposure of the mixture, wherein irradiating the mixture defluorinates the PFAS.

14. The method of claim 13, wherein the micelles remain stable at temperatures above approximately 25° C.

15. The method of claim 13, wherein the at least one UV light source includes a low-pressure or a medium-pressure UV lamp.

16. The method of claim 13, wherein the mixture has a temperature that is maintained between about 40° C. to about 65° C.

17. The method of claim 13, wherein the mixture has a pH in the range of about 10 to about 11.

18. A system for defluorinating per- and polyfluorinated substances (PFAS) in semi-solid slurries, comprising:
a semi-solid slurry including liquid, solid, and PFAS;
an electron donor;
a surfactant; and
an ultraviolet (UV) light source;
wherein the electron donor and the surfactant are combined with the semi-solid slurry to form a mixture; and
wherein the electron donor is capable of releasing hydrated electrons upon UV light irradiation from the UV light source.

19. The system of claim 18, further comprising a control system including a temperature control sensor and a pH regulation mechanism.

20. The system of claim 18, wherein the mixture has a temperature that is maintained between about 40° C. to about 65° C.
